(19) United States
(12) Patent Application Publication
(10) Pub. No.: US 2012/0148714 A1
(43) Pub. Date: Jun. 14, 2012

(54) METHOD OF MONITORING BREAKING EGGS BY AN EGG BREAKING APPARATUS IN A CYCLIC PROCESS

(75) Inventor: Jan Holm HOLST, Odense N (DK)

(73) Assignee: Sanovo Technology A/S, Odense NV (DK)

(21) Appl. No.: 12/967,796

(22) Filed: Dec. 14, 2010

(51) Int. Cl. A23L 1/32

(52) U.S. Cl. 426/298

(57) ABSTRACT

The invention relates to a method of monitoring breaking of eggs by an egg breaking apparatus in a cyclic process, where eggs are broken using a plurality of egg breaking devices, each egg breaking device breaking one egg having shell and contents at a time and where the contents of each egg is collected in an egg receiving device, each egg receiving device receiving the contents of only one egg in each process cycle. An operator monitors the contents received in the egg receiving devices and identifies egg receiving devices containing abnormal contents using a pointing device. This identification is detected by a detection device and communicated to a reject mechanism, which causes the contents of the identified egg receiving device to be discharged into a rejected product receptacle. The detection device may be a remote sensor, an integrated part of the pointing device or a device located on each of the egg receiving devices.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to a method of monitoring breaking of eggs in a cyclic process by an egg breaking apparatus, where eggs are broken by a plurality of egg breaking devices, each egg breaking device breaking one egg having shell and contents at a time. The contents of each egg are collected in an egg receiving device, each egg receiving device receiving the contents of only one egg in each process cycle. Remains held by each egg breaking device after the breaking of the eggshell and the collection of the contents are discharged to a waste receptacle and the contents of each egg receiving device are discharged into one or more product receptacles. At least one operator monitors the contents received in the egg receiving devices, when in an inspection area of the apparatus, and identifies egg receiving devices containing abnormal contents.

Such a method is known for example from U.S. Pat. No. 5,460,083, U.S. Pat. No. 5,613,429 and WO89/05097. In these the operator identifies an egg receiving device containing an inedible egg by activating an arm on the egg receiving device and the contents of the egg receiving devices are discharged into difference receptacles depending on the position of the arm. Mixed eggs, where the yolk has ruptured and spilled into the albumen, may be identified in a similar manner by moving the arm to another position.

These methods have proven very reliable and efficient in practice, but as the machines used for breaking the eggs become bigger and bigger and run at still higher speeds, the work of the operators becomes increasingly difficult.

One way of overcoming this problem would be to simply automate the process as suggested in U.S. Pat. No. 5,858,434 and U.S. Pat. No. 3,137,330, but in some countries sanitary requirements, such as those set by the U.S. Food and Drug Administration, prescribe human inspection of all eggs intended for human consumption.

It is therefore the object of the invention to provide a method of manually monitoring the breaking of eggs in a cyclic process, which is less sensitive to the dimensions and pace of the machine.

### BRIEF SUMMARY OF THE INVENTION

The object of the invention is achieved with a method, where the operator(s) use(s) a pointing device for the identification of egg receiving devices containing abnormal contents, and where an identification made by an operator is detected by a detection device and communicated to a reject mechanism, which causes the contents of the identified egg receiving device to be discharged into a rejected product receptacle.

In this way the operator is capable of identifying egg receiving devices located at a distance without having to lean over the machine to activate a mechanism on the egg receiving device in question and may even reach further than his arms length, thus allowing the use of bigger machines.

The pointing and detection devices may be embodied in many different ways as will be explained below. The detection device will, however, normally be either a remote sensor arranged at a distance from the egg receiving devices when it passes the inspection area of the egg breaking apparatus, an integrated part of the pointing device or located on each of the egg receiving devices.

The identification may be achieved using sound or light, but a method based solely on geometry and/or directly touching the egg receiving device containing abnormal contents is also feasible.

An example of a remote sensor is a vision-based system, such as a digital camera connected to a computer either directly or wirelessly. The identification may then in principle be any that can be detected by the vision-based system, such as holding a coloured object or a light source at or above the egg receiving device in question. A light source has the advantage that it can be switched on and off making it easy to tell when an identification is actually made and when the pointing device is simply being moved from one position to another. The same effect may be achieved by switching the detection device, in this case the camera, on and off.

At present it is considered advantageous to use a pointing device with a light source at one end, which is constantly on, and a camera running continuously and producing a continuous output. When the operator activates a trigger mechanism, the detection device isolates an image from the continuous output, locates the light source in this image, uses this location to determine the identity of the egg receiving device identified and communicates this identity to the reject mechanism. A computer vision system, where camera and image processing equipment is integrated, may advantageously be used, but it is of course also possible to use separate devices.

Another option is to use a pointing device including a sound source and an audio-based detection device. This may be advantageous in environments where a vision-based system is likely to be disturbed by e.g. reflections from process equipment.

When using light or sound the wave length/frequency should be chosen so that the risk of disturbance is minimized and the working environment of the operator should also be considered. Infrared light and ultrasound will be applicable in most cases, but using light or sound, which is visible/audible to humans, has the advantage that the operator will get a positive indication that the identification has been correctly made. It is of course possible to combine light and sound so that one serves the actual identification, while the other is used as an indication to the operator. A combination may also be used to provide a double detection system, which is less sensitive to disturbances and will work even in the event of malfunction on one system. The combination of difference types of light or sound is of course also possible and may possess the same advantages as described above.

Another example of a remote detection device is an optical or acoustic X-Y telemeter. The pointing device then includes an indication member capable of reflecting an optical or acoustic signal emitted by the telemeter. When the operator positions the indication member at or in the vicinity of an egg receiving device containing abnormal contents, the reflected signal depends on the distance to the telemeter in two dimensions, X and Y, and thus gives a unique identification of the position of the egg receiving device.

An example of a detection device, which is an integrated part of the pointing device, is an angle meter detecting the angle of the pointing device, which is then typically an elongated member having a free end and an end connected to a fixed point. When the operator points the free end at an egg receiving device containing abnormal contents, the angle of the elongated member in two dimensions corresponds to a particular position within the system. It is not necessary to actually touch the egg receiving device with the pointing device, which allows the method to be used in relatively big machines, but touching will of course give the most precise identification. If choosing a non-touch method the pointing device may be fitted with a laser pointer or the like to assist the operator. The length of the pointing device, which may have to be telescopic, may be a decisive factor when choosing between a touch and a non-touch system.

Examples of detection devices located on each of the egg receiving devices are a capacitive sensor, a resistance sensor or a pressure sensor. Touching such a sensor with the pointing device results in a signal, which can then be transmitted to the reject mechanism. As mentioned above a direct touch of the egg receiving device provides a precise identification, but considering the number of egg receiving devices and the operating speed of modern egg breaking apparatuses it will make great demands on the operator who must be able to hit the sensor accurately.

Another option is to provide a detection device on each of the egg receiving devices in the form of a receiver, which the operator hits with a ray or light or sound emitted from the pointing device. This option allows the operator to be positioned further away but, again, considering the number of egg receiving devices, such methods makes great demands on the precision of the operator.

Common to all of the embodiments described above is that the signal from the detection device is transmitted to the reject mechanism. The interpretation of the signal from the detection device and the communication to the reject mechanism will usually be performed using a computer system, programmed according to the method used. When for example using a vision-based system an image of the inspection area of the apparatus is analysed using an image processing program, which is readily available to the skilled person. This results in an identification of the egg receiving device, which may be based either on a position within the system at the time of detection combined with process speed, or on a numbering of the egg receiving devices, which can be read directly on the image or read by the detection device using for example RFID tags on each egg receiving device.

Depending on the method used, the detection device and/or pointing device may be switch on and off so that the system is only active when needed. As an example, a digital camera in a vision-based system may be in a passive mode during normal operation and activated by the operator to take a picture once he has identified an egg receiving device containing abnormal contents. Another example would be to use a pointing device, such as the angle meter described above, which is switch on for a short period when an identification is made and then switched off again.

The reject mechanism too may be embodied in many ways depending on the method used. One example is a physical mechanism pushing the arm of a prior art egg receiving device to the side when receiving a signal from the detection device, so that the egg receiving device is emptied into the rejected product receptacle in the known manner. Another is to employ a magnetic lock on each egg receiving device, which is selectively released by the reject mechanism. In that case the reject mechanism will have to be located close by the rejected product receptacle and it is to be understood that the position of the reject mechanism will depend on the type of mechanism chosen.

Usually the detection device will be an automated system comprising a sensor detecting an identification signal, which may come from different sources depending on the method employed, as well as a computer system processing the signal and communicating a reject order signal to the reject mechanism. The interconnection of different parts of the detection device and the communication with reject mechanism will often be wireless but does not have to be. Likewise, the different components used for the method according to the invention may be integrated, an example being that the computer system of the detection device may be arranged together with the reject mechanism.

### BRIEF DESCRIPTION OF THE SEVERAL VIEWS OF THE DRAWING

Examples of the invention will now be explained below with reference to the very schematic drawings, in which:

FIG. 1 is a sketch of an egg breaking apparatus,

FIG. 2 is a perspective, partially cut away sketch of the inspection area of an egg breaking apparatus, where a remote detection is employed,

FIG. 3 is a sketch corresponding to that in FIG. 2, but where the detection devices is a telemeter,

FIG. 4 is a sketch corresponding to that in FIG. 2, but where detection devices are located on the egg receiving devices, and

FIG. 5 is a sketch corresponding to that in FIG. 2, but where the detection device is part of the pointing device.

### DETAILED DESCRIPTION OF THE INVENTION

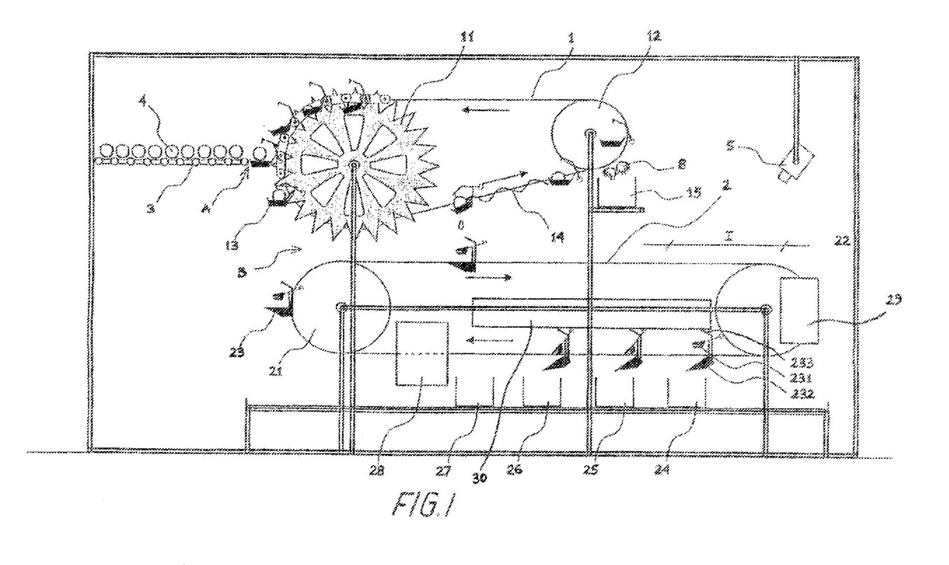

A sketch of a typical egg breaking apparatus as known from WO2007/095943, U.S. Pat. No. 5,858,434, U.S. Pat. No. 5,613,429 and WO89/05097 is shown in FIG. 1. The apparatus comprises two separate chains 1, 2 mounted on toothed turning wheels 11,12,21,22, where the uppermost chain 1 carries a plurality of egg breaking devices 13 and the lowermost chain 2 carries a plurality of egg receiving devices 23. Even though only a few egg breaking and receiving devices are shown on the respective chains, it is to be understood that in practise the number of devices on each chain are larger such that they are evenly spaced with substantially the same mutual distance on both chains. Similarly, even though FIG. 1 shows only a single row of egg breaking and receiving devices it is to be understood that each of these devices may represent a column of devices extending perpendicularly to the plane of the drawing. Such columns may be mounted on horizontal bars stretching between two parallel chains, each column including for example eight or sixteen separate egg breaking or receiving devices.

A feeder 3 carries eggs 4 towards the uppermost chain and delivers them to the egg breaking devices 13 at point A, each egg breaking device receiving one egg in each process cycle. For enabling the separate discharge of albumen and yolk each egg receiving device 23 is equipped with a yolk holder 231 and an albumen cup 232 as will be well known to the skilled person.

The uppermost chain 1 is driven in a counter-clockwise direction and the lowermost chain 2 in a clockwise direction as indicated by the respective arrows, the speed of the two chains being substantially identical. In this way each egg breaking device 13 will meet an egg receiving device 23 at point B and the pair will travel together until reaching the upper right turning wheel 12.

The actual breaking of the egg 4 takes place in the vicinity of point B and the contents of the egg are then drained from the eggshell held by the egg breaking device 13 into the egg receiving device 23 underneath it.

When reaching the turning wheel 12 the egg breaking device 13 travels upwards away from the egg receiving device 23, and the emptied eggshell 8 is discharged into the waste receptacle 15.

After passing the upper right turning wheel 12, the egg receiving device 23 travels onwards along the chain 2 towards the turning wheel 22, the distance I between the turning wheels 12,22 of the two chain systems serving as an inspection area, where the contents of the egg receiving devices are inspected. If an operator detects a rotten or otherwise unacceptable egg, he pushes an 233 on the egg receiving to another position.

In the embodiment shown, the apparatus also includes an automated reject mechanism 29, where the arm 233 is pushed to a third position if the contents do not live up the certain criteria. This may be a mechanism distinguishing between eggs properly separated and whole-eggs, where yolk and albumen has been mixed, as known from the prior art or a more sophisticated mechanism as will be elaborated below.

When reaching the underside of the chain 2, the arms 233 on the egg receiving devices 23 come into engagement with different members (not shown) of the release mechanism 30 depending on their current position. This results in the contents of the egg receiving device 23 being emptied into one or more product receptacles. In the simplest form eggs of an acceptable quality are discharged into one receptacle, whereas contaminated or otherwise unacceptable eggs are discharged into another. However, in the embodiment shown the apparatus is equipped with four product receptacles; an albumen receptacle 24 for receiving pure albumens, a yolk receptacle 25 for receiving pure yolks, a whole-egg receptacle 26 for receiving mixtures of albumen and yolk and a rejected product receptacle 27 for receiving otherwise contaminated or unacceptable eggs.

After the emptying the egg receiving devices 23 pass through a washer or disinfector 28, which may treat all egg receiving devices or possibly only those, which have contained a contaminated egg or a mixture of albumen and yolk. The apparatus may, however, also function without the washer/disinfector or this may be located off-line.

The amount of eggs that can be processed per hour of course depend on the number of rows of egg breaking and receiving devices arranged across the machine, but modern egg breaking apparatuses process more than 10.000 eggs per row per hour.

In the following, reference will be made to an apparatus as the one described above, but it is to be understood that the invention will also work with egg breaking apparatuses of a different configuration. Likewise, when the definite form “the operator” is used it should be understood that this is only for the sake of simplicity and that two or more operators will often work together on the same egg breaking apparatus, performing substantially the same task.

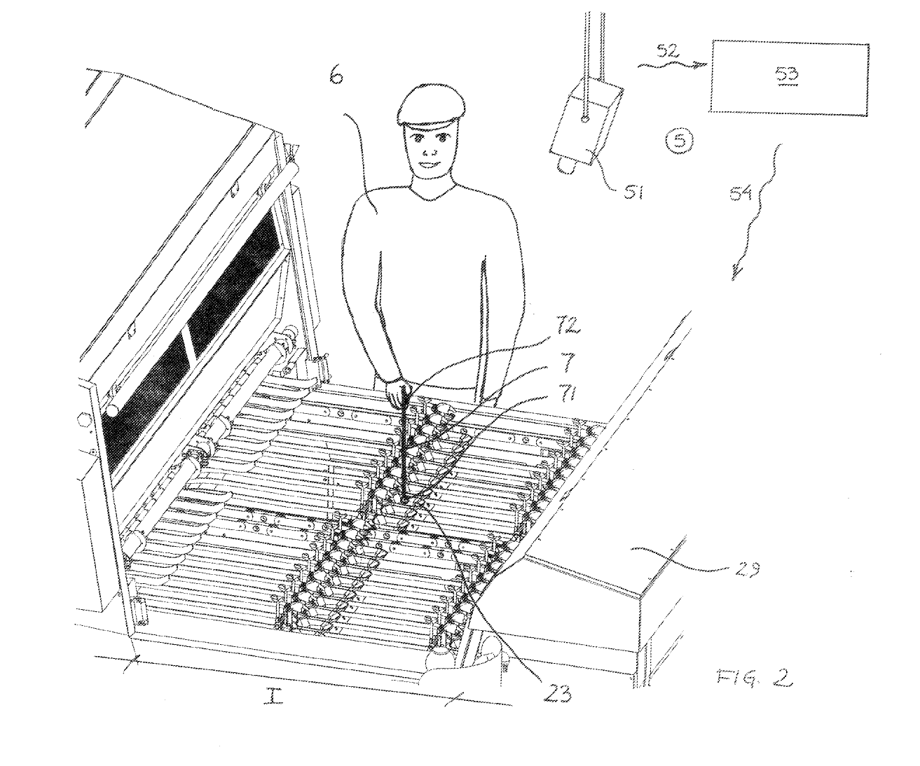

In FIGS. 1 and 2 the detection device 5 is of a remote type and arranged above the inspection area I. In FIG. 1 it is a computer vision system, where camera and an image processing unit is integrated and in it includes a separate digital camera 51 looking down on the egg receiving devices 23 passing through the inspection area. For the sake of simplicity only two columns of egg receiving devices are shown, but it is to be understood that the egg receiving devices are usually located close by one another so that they form a substantially continuous two dimensional array.

An operator 6 holds a pointing device 7 in the form of a rod so that its end is located above one of the egg receiving devices 23, which he has discovered contains an abnormal egg. In this embodiment the rod is provided with a light source 71 at the end and a power source (not visible) for the light source, such as a rechargeable battery, is housed in the rod. The light source 71 could be a group of red or blue diodes, which will give a good contrast to the with and yellow colours of the eggs and allow the operator to see that the light is actually on, but it is also possible to use wavelengths that are not visible to the human eye as well as other types of light sources.

Here the light source 71 is held directly above the egg receiving device 23 containing abnormal contents, but it is also possible to use it to illuminate at least a portion of the egg receiving device, which is typically made from a white or opaque plastic material. Another alternative is to illuminate an area in the vicinity of the egg receiving device. In any event the detection device should be programmed to look for the type of identification chosen, which is a question of simple programming of a known image recognition program.

When the rod 7 is in place above the correct egg receiving device 23, the operator 6 hits an on/off button 72 to turn the light on. In this embodiment this button is also remotely connected to the trigger mechanism of the digital camera 5, so that an image of the inspection area I is generated when the light on the rod is switched on. Separate buttons or devices (not shown) may be provided for triggering the light in the pointing device and the camera, respectively.

An alternative would be to use a video camera running continuously and to continuously analyse the output to detect light signals from the pointing device. A middle course is to isolate still images from the video streaming when the on/off button is activated by the operator.

The camera 51 is connected via a wireless connection 52 to a computer system 53, which processes the image and sends a signal 54 to the reject mechanism 29 that the contents of the egg receiving device thus identified must be emptied into the rejected product receptacle 27.

In this embodiment the identification signal 54 sent from the computer system 53 to the reject mechanism 29 is based on the immediate running speed of the apparatus. If an egg receiving device 23 was identified at a particular position at the point in time when the image was generated it will reach the reject mechanism 29 at a well defined later point in time, which depends solely on the running speed of the apparatus. This means that the signal 54 sent from the computer to the reject mechanism only needs to include an identification of the row in which the egg receiving device is present and the time when it will reach the reject mechanism.

The reject mechanism 29 has not been detailed on the drawing as it may be embodied in many different ways, one being a mechanism which pushes an arm on the egg receiving device to the side in the same way as it is done manually by the inspector in the prior art. Such mechanisms have already been employed in automated systems distinguishing whole-eggs from those where the yolk and albumen have been separated properly, and the skilled person will have no problems expanding this to include an extra position of the arm.

In stead of using a light source, the pointing device 7 may simply be a rod with a colour that is clearly distinguishable from the colours of the eggs and egg receiving devices, possibly having a coloured tip or a coloured object attached to the free end. This eliminates both the need for a power source and the risk of the pointing device malfunctioning. An on/off function can be achieved simply by making the pointing device appear different when turned so that one side has the colour used for the identification of abnormal eggs while another is of a neutral colour.

Another alternative to the use of light is to use sound and to replace the camera 51 with a microphone. This may be advantageous in environments where a vision-based system is likely to be disturbed by e.g. reflections from process equipment, but here too the frequency of the identification signal should be chosen to avoid disturbances from the environment.

As when using light, the use of a frequency detectable by the human ear will allow the operator to know, when an identification is actually made and an on/off switch is considered an advantage.

The microphone used should of course be of a type, which is capable of detecting the direction of the sound. This may be achieved with specialized devices, which are well-known to persons skilled in the art, but it is of course also possible to employ a set of simple microphones and a signal processing algorithm run by the computer 53.

The systems described above could be combined in order to provide a system of increased accuracy. If the light source fails the camera may nonetheless be able to detect the colour of the pointing device and a combined sound and light signal will provide an improved accuracy in the identification. The latter may be advantageous since, due to the processing speed, the operator 6 may not always be able to hold the pointing device 7 at an exact intended position in relation to the egg receiving device 23 to be identified.

As a supplement or alternative to the processing of the information contained in the image or sound identification and being based on the running speed of the system, each egg receiving device can be provided with an RFID tag and the detection device 5 with a RFID tag reader. When the identification is made by the operator 6, the computer system 53 reads the tag of the egg receiving device in question and communicates this to the reject mechanism 29. The identification may depend on light of sound as described above or, if using active RFID tags, the pointing device could include a tag activator, prompting the tag to send out a signal. Once the reject mechanism detects the presence of this particular tag, the contents of the egg receiving device 23 is rejected. In this way the rejection of abnormal eggs becomes independent on the speed of the system and thus of any delays or stops.

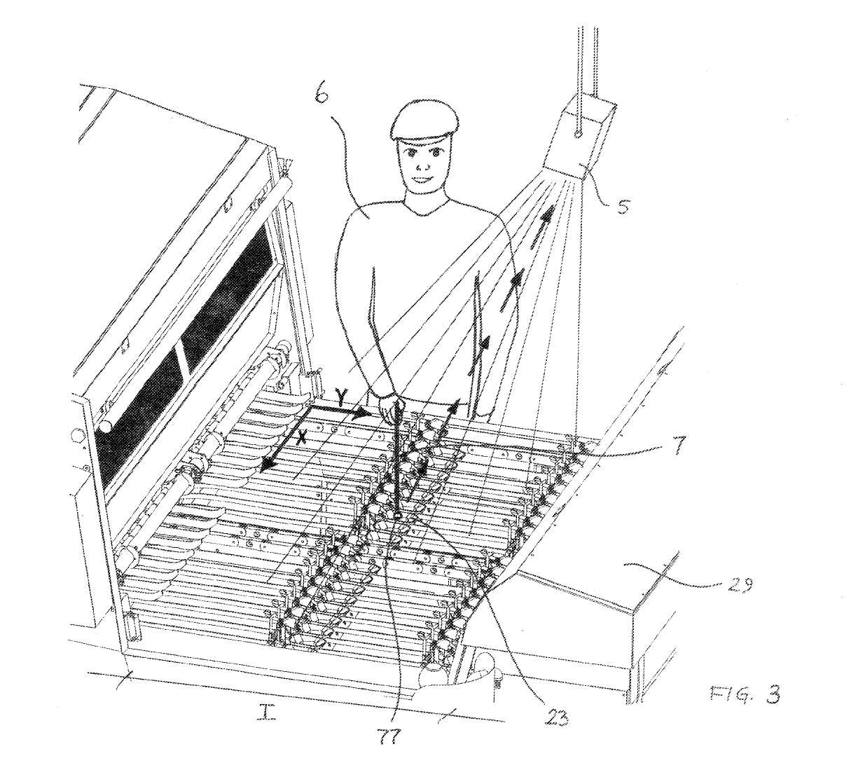

In the embodiments described above the system depends on sound or light being emitted, either actively or passively, from a pointing device 7 held at or above the egg receiving device 23 containing abnormal contents. The detection device 5 may, however, also send out a signal and register a reflection from the tip of the pointing device 7 held by the operator 6 at or above the egg receiving device 23 in question as shown in FIG. 3. Such a detection device, which is also known as an X-Y telemeter, measures the time it takes before the reflection is detected and uses this to determine the distance to the tip of the pointing device in two dimensions, X and Y. The pointing device is preferably provided with indication member 77, which is particularly good at reflecting the optical or acoustic signal emitted by the telemeter, said indication member possibly being a part of the pointing device having different surface characteristics from the rest. As in the embodiments described above, the system may be provided with an on/off switch.

It is of course also possible to provide a telemeter at the end of the pointing device 7 to measure a distance to a fixed point on the apparatus, ceiling or the like, but this will make the pointing device relatively heavy and unhandy.

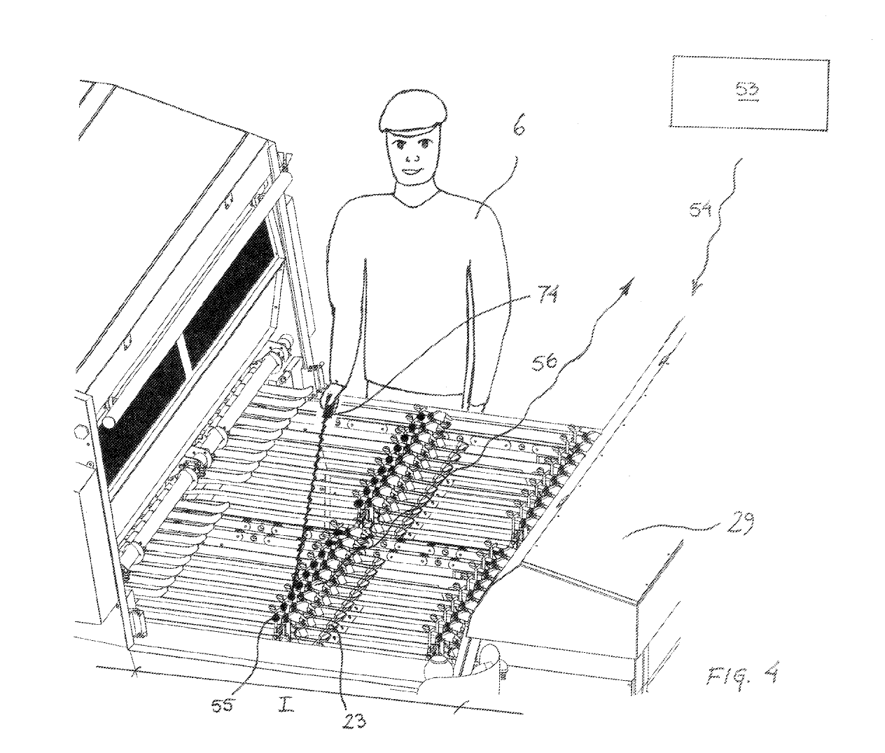

Referring now to FIG. 4, an active component 55 may also be arranged on the egg receiving device 23 itself. This is exemplified with a light sensitive tag, which sends a signal 56 to the computer 53 when being hit by light of a certain wavelength. As explained above the signal 56 may be a simple indication of position or a indication of identity. In the first case, the computer 53 calculates the data needed by the reject mechanism and sends 54 these to the reject mechanism; in the second case a signal may be sent directly to the reject mechanism 29. Sensors sensitive to sound may be used in a similar manner.

This method of identifying the egg receiving devices 23 allows the use of a small pointing device 74, such as a traditional laser pointer, which has obvious advantages to the working conditions of the operator 6. Depending on the size and running speed of the apparatus it will, however, also demand precision on the part of the operator who has to hit the sensor precisely.

Sensors 55 on the egg receiving device 23 can also be of a type reacting to a direct touch by the pointing device, which would then be rod-shaped as in FIG. 2 or 3. This can be achieved with a capacitive sensor, a resistance sensor or a pressure sensor.

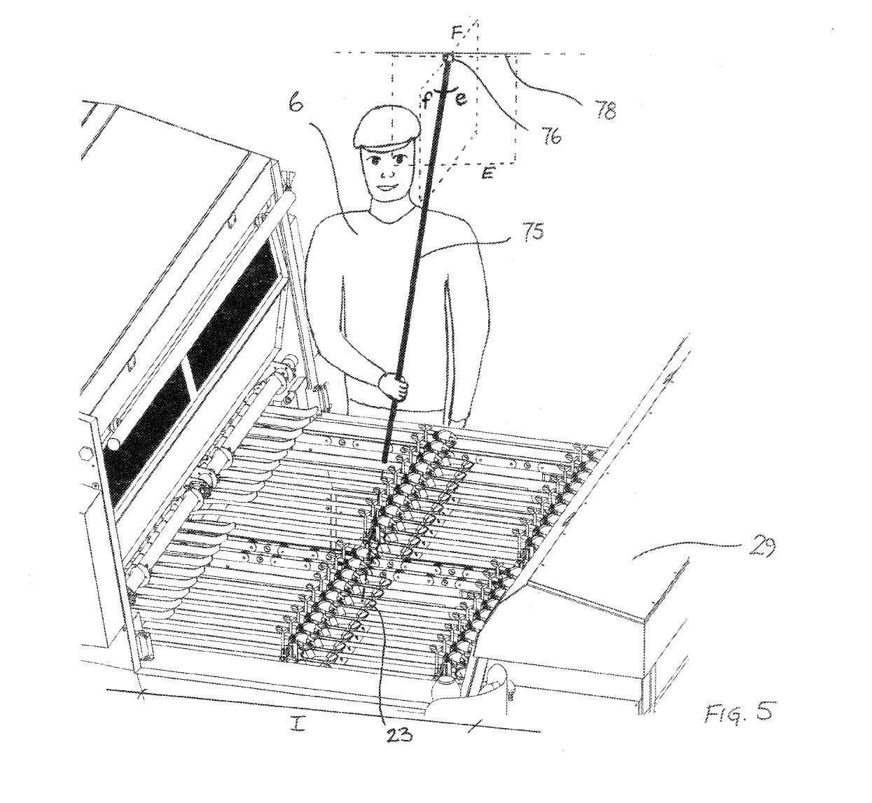

All of the embodiments above are based on a signal being sent wirelessly from one device to another. It is, however, also possible to employ a system based on direct contact. Referring now to FIG. 5, this can be done using a detection device in the form of an elongate pointing device 75 attached to a fixed point 76. When the operator 6 has pointed the pointing device at an egg receiving device 23 containing abnormal contents, an angle meter (not shown) measures the angles e and f of the pointing device in relation to two perpendicular planes E and F, respectively, thereby determining the exact position.

As for the embodiments given above, an on/off switch may be used to indicate when the identification is actually being made as opposed to when the pointing device is simply being moved above one egg receiving device to reach another.

Since the distance from the fixed point 76 to the different egg receiving devices 23 varies, a pointing device of a certain length will normally not be able to touch all of them and a telescopic pointing device may therefore be employed. If using a pointing device of a fixed or limited length is may be provided with a laser pointer or like light source to assist the operator in pointing correctly.

An anglemeter may also be combined with a telemeter in which case it will suffice to measure the angle in relation to one plane.

The embodiments described above are only to be regarded as illustrations of possible modes of realizing the invention and are in no way to be intended to limit the scope of the claims. It should also be noted that different embodiments of pointing devices, detection devices and reject mechanisms described above may be altered and combined in other ways without departing from the scope of the invention. Finally it is emphasized that the method according to the invention is in no way limited to use on egg breaking apparatuses of the design described above.

1. A method of monitoring breaking of eggs by an egg breaking apparatus in a cyclic process, comprising the steps of:
breaking eggs using a plurality of egg breaking devices, each egg breaking device breaking one egg having shell and contents at a time,
collecting the contents of each egg in an egg receiving device, each egg receiving device receiving the contents of only one egg in each process cycle,
discharging the remains held by each egg breaking device after the breaking of the eggshell and the collection of the contents to a waste receptacle and discharging the contents of each the egg receiving device into one or more product receptacles,
having at least one operator monitoring the contents received in the egg receiving devices, in an inspection area of the apparatus, and identifying egg receiving devices containing abnormal contents,
using a pointing device operated by the operator(s) for the identification of egg receiving devices containing abnormal contents,
using a detection device for detecting an identification made by an operator and communicating it to a reject mechanism, and
causing the contents of the identified egg receiving device to be discharged into a rejected product receptacle.

2. A method according to claim 1, wherein the detection device is chosen from the group consisting of: a remote sensor, an integrated part of the pointing device and a device located on each of the egg receiving devices.

3. A method according to claim 1, wherein the pointing device includes a light source and the detection device is a vision-based system.

4. A method according to claim 1, wherein the pointing device includes a sound source and the detection device is an audio-based system.

5. A method according to claim 3, wherein the identification of an egg receiving device containing abnormal contents is performed with the light from the light source in a manner chosen from the group consisting of: illuminating at least a portion of the egg receiving device, illuminating an area in the vicinity of the egg receiving device, and holding the light source above the egg receiving device.

6. A method according to claim 3, wherein the light source is smaller than the egg receiving device, when seen by the detection device, and is constantly on.

7. A method according to claim 3, wherein the detection device includes an X-Y telemeter and the pointing device includes an indication member reflecting the signal emitted by the telemeter, and where the operator positions the indication member at the egg receiving device containing abnormal contents.

8. A method according to claim 1, wherein the pointing device includes an elongated member having a free end and an end connected to a fixed point and where the detection device includes an angle meter detecting at least one angle of the elongated member.

9. A method according to claim 8, wherein the identification of an egg receiving device containing abnormal contents is performed by pointing the free end of the elongated member at this particular egg receiving device.

10. A method according to claim 8, wherein the identification of an egg receiving device containing abnormal contents is performed by touching this particular egg receiving device with the free end of the elongated member.

11. A method according to claim 1, wherein, when indentifying an egg receiving device containing abnormal contents, the operator touches a detection device on said egg receiving device with the pointing device.

12. A method according to claim 3, wherein, when indentifying an egg receiving device containing abnormal contents, the operator hits a detection device on said egg receiving device with a beam emitted from the pointing device.

13. A method according to claim 1, wherein an egg receiving device containing abnormal contents is identified using an RFID tag attached thereto.

14. A method according to claim 1, wherein the operator activates the pointing device when having indentified an egg receiving device containing abnormal contents.

15. A method according to claim 1, wherein the operator activates the detection device when having indentified an egg receiving device containing abnormal contents.

16. A method according to claim 1, wherein the detection device includes a computer system.

17. A method of monitoring breaking of eggs by an egg breaking apparatus in a cyclic process, comprising the steps of:
breaking eggs using a plurality of egg breaking devices, each egg breaking device breaking one egg having shell and contents at a time,
collecting the contents of each egg in an egg receiving device, each egg receiving device receiving the contents of only one egg in each process cycle,
discharging remains held by each egg breaking device after the breaking of the eggshell and the collection of the contents to a waste receptacle and discharging the contents of each the egg receiving device into one or more product receptacles,
having at least one operator monitoring the contents received in the egg receiving devices, in an inspection area of the apparatus, and identifying egg receiving devices containing abnormal contents,
using a pointing device including a light source at an end thereof and being operated by the operator(s) for the identification of egg receiving devices containing abnormal contents,
detecting an identification made by an operator using a vision-based detection device, which includes a computer system, and communicating it to a reject mechanism, and
causing the contents of the identified egg receiving device to be discharged into a rejected product receptacle.

18. A method according to claim 17, wherein the operator activates the pointing device when having indentified an egg receiving device containing abnormal contents.

19. A method according to claim 17, wherein the operator activates the detection device when having indentified an egg receiving device containing abnormal contents.

20. A method according to claim 19, wherein the detection device is camera providing a continuous output and wherein at least one image is isolated from the camera output when the operator activates the detection device.
